(19) United States
(12) Patent Application Publication
(10) Pub. No.: US 2003/0051654 A1
(43) Pub. Date: Mar. 20, 2003

(54) Trailer docking assistance device

(76) Inventors: Joe M. Jarosek, Temple, TX (US); Jerry Marshall, Temple, TX (US)

Correspondence Address: DAVID G. HENRY, 900 Washington Avenue, 7th Floor, P.O. Box 1470, Waco, TX, 77603-1470, US

(21) Appl. No.: 09/955,573

(22) Filed: Sep. 18, 2001

(51) Int. Cl. B60D 1/00

(52) U.S. Cl. 116/28 R; 280/477; 33/264

(57) ABSTRACT

The invention is of a device which provides the driver of a towing vehicle with a visual indication of the precise position and alignment of a towing vehicle's hitch ball (or other vehicle-side docking device) with the trailer's ball receiver (or other trailer-side docking device). Embodiments include an adjustable support for a position indicating device or “marker” which support attaches to the towing vehicle (in the bed of a pickup truck, for example) and can be adjusted whereby being marker or is positioned for indicating the point at which, when the trailer's receiver is juxtaposed thereto, the receiver and the vehicles docking device (usually a hitch ball) will be properly positioned and aligned for attachment.

### BACKGROUND OF THE INVENTION

1. Field of The Invention

The present invention is directed toward easing the docking of a trailer and a towing vehicle, principally an open bed pickup truck or similar vehicle in which the docking site may be viewed from the driver's compartment.

2. Background Information

Properly aligning a trailer's hitch ball receiver with a vehicle's hitch ball is often difficult and requires a great deal of trial and error. This is particularly true when the trailer is large and cannot readily be moved by an individual in order to manually line up the receiver with the hitch ball (or hitching structure). The actual juxtaposition of receiver and hitch ball is not usually visible to the driver of a towing vehicle. Therefore, the driver must simply guess when the vehicle is properly oriented and positioned for docking with a trailer.

Certainly, one could imagine high-tech solutions to this problem, including such things as closed circuit video monitors in a driver's compartment with suitably oriented camera(s) for monitoring the docking operation, laser guidance systems, etc. However, such solutions amount to “overkill” and all are too costly for most who would benefit should systems.

It would well serve those who must dock vehicles at trailers to provide something which is both effective and highly cost-effective to aid in docking trailer receiving mechanisms and vehicle docking devices.

### SUMMARY OF THE INVENTION

In view of the foregoing, it is an object of the present invention to provide a visualization device which aids the driver of a towing vehicle to properly oriented and position the vehicle for docking with a trailer.

It is another object of the present invention to provide a device which visually indicates when a vehicle mounted trailer docking device is properly positioned relative to a trailer's docking device for engaging the one to the other for towing operations.

It is another object of the present invention to provide a device which obviates the trial and error of trailer docking operations.

In satisfaction of these and related objects, the present invention provides a very simple, effective, and cost-effective (as well as mobile) device which provides the driver of a towing vehicle with a visual indication of the precise position and alignment of a towing vehicle's hitch ball (or other vehicle-side docking device) with the trailer's ball receiver (or other trailer-side docking device). As will be detailed in the specification to follow, any embodiment of the present invention very simply involves an adjustable support for a position indicating device or “marker” which support attaches to the towing vehicle (in the bed of a pickup truck, for example) and can be adjusted whereby being marker or is positioned for indicating the point at which, when the trailer's receiver is juxtaposed thereto, the receiver and the vehicles docking device (usually a hitch ball) will be properly positioned and aligned for attachment.

Embodiments of the present invention are envisioned as being most beneficial in the context of docking boost neck trailers with bed-mounted hitch balls.

### BRIEF DESCRIPTION OF THE DRAWINGS

FIG. 1 is an elevational, schematic view of a trailer docking assistance device of the present invention shown in context of use with a boost neck trailer hitch neck and eight truck bed-mounted hitch ball.

FIG. 2 is a top plan, conceptual view of a pickup truck bed with a bid mounted hitch ball therein, with the device of the present invention being used to for providing visual confirmation to the driver of the proper alignment and positioning of the trailer's receiver and the hitch ball.

### DETAILED DESCRIPTION OF THE PREFERRED EMBODIMENT

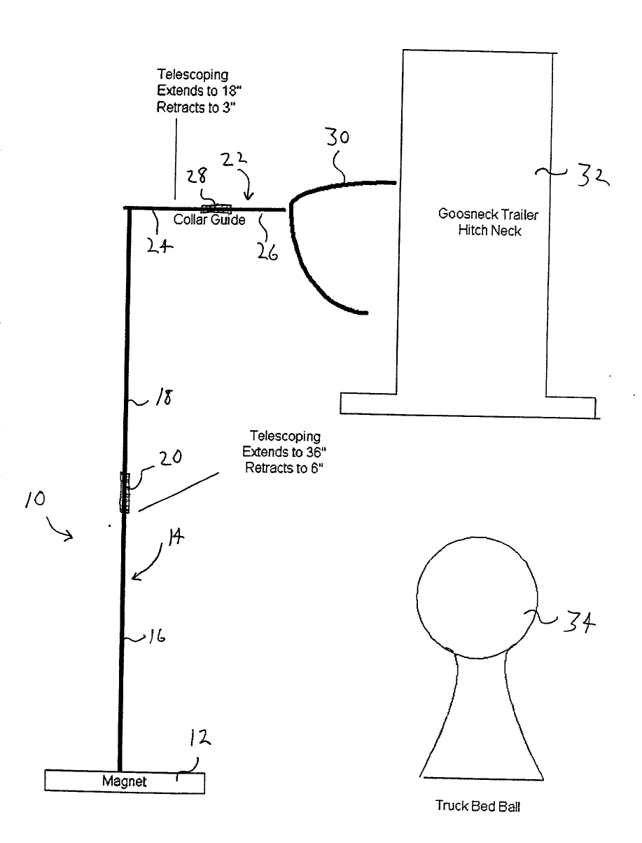

Referring to FIG. 1, the trailer docking assistance device of the present invention is identified generally by the reference numeral 10. Device 10 includes, in the preferred embodiment, a magnetic base 12. The magnetic base provides means by which device 10 can be securely, but reversibly, attached to a towing vehicle, such as in the bed of pickup truck. Of course, alternative attachment may be provided (both temporary or permanent) which involves screws, clamps, adhesives, etc., but the just-described magnetic base is believed to be the preferred mode because of simplicity and mobility.

Extending upward from magnetic base 12 is a telescopic vertical support rod assembly 14. Telescopic vertical support rod assembly 14 includes, in the preferred embodiment, telescopically mated rods 16 and 18 with a knurled frictional rod securing collar 20 (or set screw type securing assembly) for securing rods 16 and 18 to a desired length.

In the preferred embodiment, a telescopic horizontal support rod assembly 22 extends from the upper limit of vertical support rod assembly 14. Horizontal support rod assembly 22 includes, in the preferred embodiment, telescopically mated rods 24 and 26 with a knurled frictional rod securing collar 28 (or set screw type securing assembly) for securing rods 24 and 26 a desired length.

Attached to the distal end of horizontal support rod assembly 22 is marker 30. In the preferred embodiment, marker is a semi circular crook which is designed to partially mate with, or envelope, the trailer's receiver (in this case the goose neck trailer hitch neck 32). Obviously, alternative embodiments for marker 30 or easily envisioned for differing situations, such as when the present device is used with other than a goose neck trailer. For example, a simple, painted dot or flag-like marker may be used to juxtapose with some structure on a trailer other than the actual receiver to nevertheless indicate when the trailer and the vehicle or properly positioned and aligned.

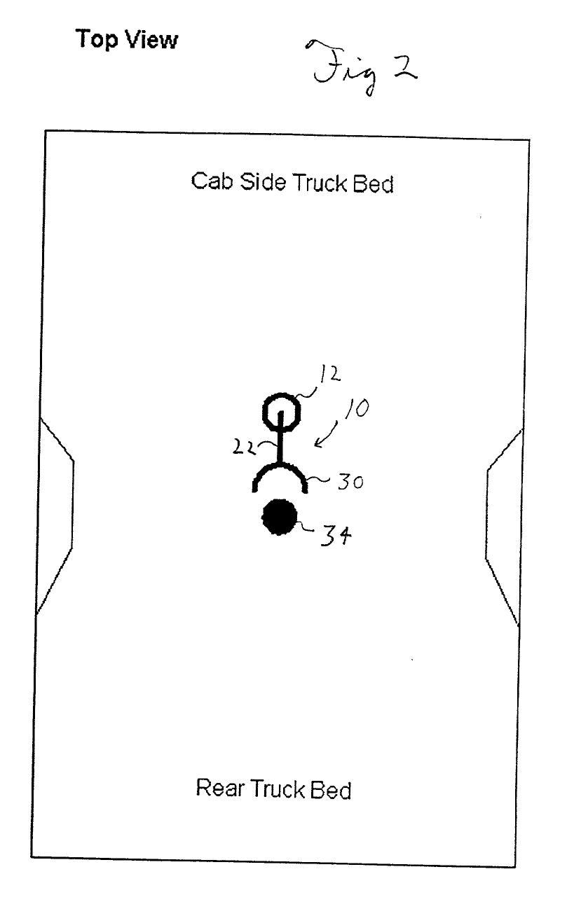

Referring in combination to FIGS. 1 and 2, and returning to the preferred embodiment for use with goose neck trailers and their mating with bed-mounted hitch balls 34, the adjustability of support rod assemblies 14 and 22 allow for a user to precisely position marker 30 such that, when the goose neck trailer hitch neck 32 mates with marker 30, hitch neck 32 will be properly aligned with hitch ball 34 for simply lowering hitch neck 32 and docking it with hitch ball 34, without having to further maneuver the towing vehicle or the trailer. This represents a considerable advantage to a driver who needs to dock such a truck and trailer, because the hitch ball 34 itself is often not visible to the driver when in the driver's seat, yet marker 30 can easily be adjusted and positioned for ready viewing by the driver.

It is believed that, while quite simple and inexpensive, the present device will provide substantial utility and obviate significant inconvenience to those who must dock towing vehicles and trailers, particularly without the assistance of other individuals.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A trailer docking assistance device comprising:
mounting means for securing said device to a vehicle;
a marker member;
adjustable support means for supporting said marker member in a user-selectable position.

2. The device of claim 1 wherein said marker member is configured to at least partially receive a trailer receiver of a trailer.
